(19) United States
(12) Patent Application Publication
(10) Pub. No.: US 2019/0041248 A1
(43) Pub. Date: Feb. 7, 2019

(54) THERMAL FLOWMETER

(71) Applicant: AZBIL CORPORATION, Chiyoda-ku (JP)

(72) Inventors: Yoshio Yamazaki, Chiyoda-ku (JP); Shinsuke Matsunaga, Chiyoda-ku (JP)

(73) Assignee: AZBIL CORPORATION, Chiyoda-ku (JP)

(21) Appl. No.: 16/039,387

(22) Filed: Jul. 19, 2018

(30) Foreign Application Priority Data
Aug. 2, 2017 (JP) 2017-149632

(51) Int. Cl. G01F 1/684; G01F 1/688

(52) U.S. Cl. CPC G01F 1/6847; G01F 1/6888

(57) ABSTRACT

A sensor unit includes a heater that heats a measurement target fluid, and outputs a sensor value that corresponds to a thermal diffusion state of the fluid heated by the heater when the heater is driven so that a difference between a temperature of the heater and a temperature of the fluid at a position where there is no thermal effect of the heater is to be equal to a set temperature difference. A processing unit calculates an estimated value obtained by multiplying the sensor value by a value obtained by dividing the set temperature difference by a difference between the temperature of the heater and a measured temperature of the fluid. A flow rate calculation unit calculates a flow rate of the fluid from the estimated value.

### CROSS-REFERENCE TO RELATED APPLICATIONS

The present application is based on and claims priority to Japanese Application No. 2017-149632, filed Aug. 2, 2017, the entire contents of which are incorporated herein by reference.

### BACKGROUND

### 1. Field

The present disclosure relates to a thermal flowmeter for measuring a flow rate by using thermal diffusion in a fluid.

### 2. Description of the Related Art

A technique for measuring the flow rate and the flow velocity of a fluid that flows through a flow passage widely used in the industrial field, the medical field, and so on. As devices for measuring a flow rate and a flow velocity, various types of devices, such as an electromagnetic flowmeter, a vortex flowmeter, a Coriolis flowmeter, and a thermal flowmeter, are available and used in accordance with the intended use. A thermal flowmeter is advantageous in that, for example, a thermal flowmeter able to sense gas, basically causes no pressure drop, and is able to measure a mass flow rate. Further, a thermal flowmeter that is able to measure the flow rate of a corrosive liquid by using a flow passage formed of a glass tube is available (see Japanese Unexamined Patent Application Publication No. 2006-010322 and Japanese Unexamined Patent Application Publication (Translation of PCT Application) No. 2003-532099). Such a thermal flowmeter for measuring the flow rate of a liquid is suitable for measuring a very small flow rate.

For thermal flowmeters, a flow rate measurement method using the difference between a temperature at an upstream position relative to a heater and a temperature at a downstream position relative to the heater and a flow rate measurement method using the power consumption of the heater are available. For example, in a case of measuring the flow rate of a liquid by using the latter method, the heater driven for warming so that the temperature difference between the heater temperature and the liquid temperature is to be constant, namely, the heater temperature is to be higher than the liquid temperature by, for example, 10° C., and the flow rate is calculated from the difference between a temperature at an upstream position relative to the heater and a temperature at a downstream position relative to the heater or from the power consumption of the heater.

However, if, for example, the flow rate abruptly changes, a thermal flowmeter fails to accurately measure the flow rate. This is because a thermal flowmeter is able to accurately measure the flow rate only after the heater temperature becomes constant. As described above, a thermal flowmeter has low responsiveness, which is an issue.

One of the possible causes of a delay in heater temperature control is the thermal capacity of a heating target object. Specifically, in a case where a measurement target is a liquid, the liquid is heated via the wall of the pipe. Therefore, the wall of the pipe is also a heating target in addition to the liquid, and the thermal capacity increases, which may lead to low responsiveness. As described above, a thermal flowmeter has an issue, that is, it is not easy for a thermal flowmeter to quickly determine the flow rate of a measurement target fluid.

### SUMMARY

The present disclosure has been made to address the above-described issue and provides a thermal flowmeter with which the flow rate of a measurement target fluid can be determined more quickly.

A thermal flowmeter according to an aspect of the present disclosure includes a sensor unit, a processing unit, and a flow rate calculation unit. The sensor unit includes a heater that heats a measurement target fluid, and is configured to output a first value that corresponds to a thermal diffusion state of the fluid heated by the heater when the heater is driven so that a difference between a temperature of the heater and a temperature of the fluid at a position where there is no thermal effect of the heater is to be equal to a set temperature difference. The processing unit is configured to calculate a second value obtained by multiplying the first value by a value obtained by dividing the set temperature difference by a difference between the temperature of the heater and a measured temperature of the fluid. The flow rate calculation unit is configured to calculate a flow rate of the fluid from the second value calculated by the processing unit.

In the thermal flowmeter described above, the processing unit may calculate the second value by multiplying the first value by the value obtained by dividing the set temperature difference by the difference between the temperature of the heater and the measured temperature of the fluid and by a preset constant.

The thermal flowmeter described above may further include a determination unit configured to determine whether a difference between the set temperature difference and the difference between the temperature of the heater and the measured temperature of the fluid is smaller than a set value. If the determination unit determines that the difference between the set temperature difference and the difference between the temperature of the heater and the measured temperature of the fluid is smaller than the set value, the flow rate calculation unit may calculate the flow rate from the first value.

The thermal flowmeter described above may further include a flow rate processing unit configured to add the flow rate calculated by the flow rate calculation unit to a value obtained by multiplying the flow rate by a time derivative value of the flow rate and by a set compensating rate to calculate a third value.

In the thermal flowmeter described above, the sensor unit may output, as the first value, a power of the heater when the heater is driven so that the difference between the temperature of the heater and the temperature of the fluid at the position where there is no thermal effect of the heater is to be equal to the set temperature difference.

In the thermal flowmeter described above, the sensor unit may output, as the first value, a temperature difference between a temperature of the fluid at an upstream position relative to the heater and a temperature of the fluid at a downstream position relative to the heater when the heater is driven so that the difference between the temperature of the heater and the temperature of the fluid at the position where there is no thermal effect of the heater is to be equal to the set temperature difference.

In the thermal flowmeter described above, the sensor unit may further include a temperature measurement unit disposed so as to be in contact with an external wall of a pipe used to convey the fluid, and configured to measure the temperature of the fluid, and the heater may be disposed so as to be in contact with the external wall of the pipe.

As described above, according to an aspect of the present disclosure, the set temperature difference by which the temperature of the heater is higher than the temperature of the fluid is divided by the difference between the temperature of the heater and the measured temperature of the fluid, and the first value is multiplied by the value obtained as a result of the division to obtain the second value. The second value is used to calculate the flow rate. Therefore, an advantageous effect is attained in which, even if the measurement target fluid is not in a thermal equilibrium state, the thermal flowmeter can determine the flow rate of the fluid more quickly.

### BRIEF DESCRIPTION OF THE DRAWINGS

FIG. 1 is a block diagram illustrating a configuration of a thermal flowmeter according to a first embodiment of the present disclosure;

FIG. 2 is a block diagram illustrating in detail a configuration of a sensor unit in the thermal flowmeter according to embodiments of the present disclosure;

FIG. 3 is a block diagram illustrating in detail another configuration of the sensor unit in the thermal flowmeter according to embodiments of the present disclosure;

FIG. 4 is a characteristic diagram illustrating changes in the difference between a heater temperature and a measured fluid temperature in response to changes in a flow rate, changes in a calculated flow rate, and changes in an estimated flow rate;

FIG. 5 is a block diagram illustrating a configuration of a thermal flowmeter according to a second embodiment of the present disclosure;

FIG. 6 is a block diagram illustrating a configuration of a thermal flowmeter according to a third embodiment of the present disclosure; and

FIG. 7 is a block diagram illustrating a hardware configuration of a processing unit, a flow rate calculation unit, a determination unit, a flow rate processing unit, and so on according to embodiments of the present disclosure.

### DETAILED DESCRIPTION

Hereinafter, embodiments of the present disclosure will be described.

### First Embodiment

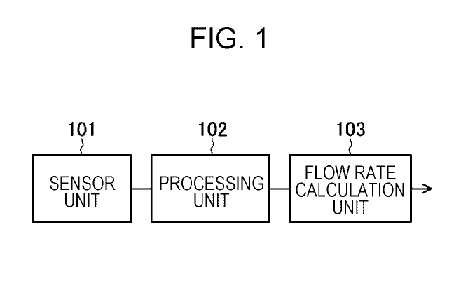

First, a thermal flowmeter according to a first embodiment of the present disclosure is described with reference to FIG. 1. This thermal flowmeter includes a sensor unit 101, a processing unit 102, and a flow rate calculation unit 103.

The sensor unit 101 includes a heater that heats a measurement target fluid, and outputs a sensor value (first value) that corresponds to a thermal diffusion state of the fluid heated by the heater when the heater is driven so that the difference between the heater temperature and the temperature of the fluid at a position where there is no thermal effect of the heater is to be equal to a set temperature difference.

The processing unit 102 calculates an estimated value (second value) obtained by multiplying the sensor value by a value obtained by dividing the above-described set temperature difference by the difference between the heater temperature and the measured fluid temperature. The flow rate calculation unit 103 calculates the flow rate of the fluid from the estimated value calculated by the processing unit 102.

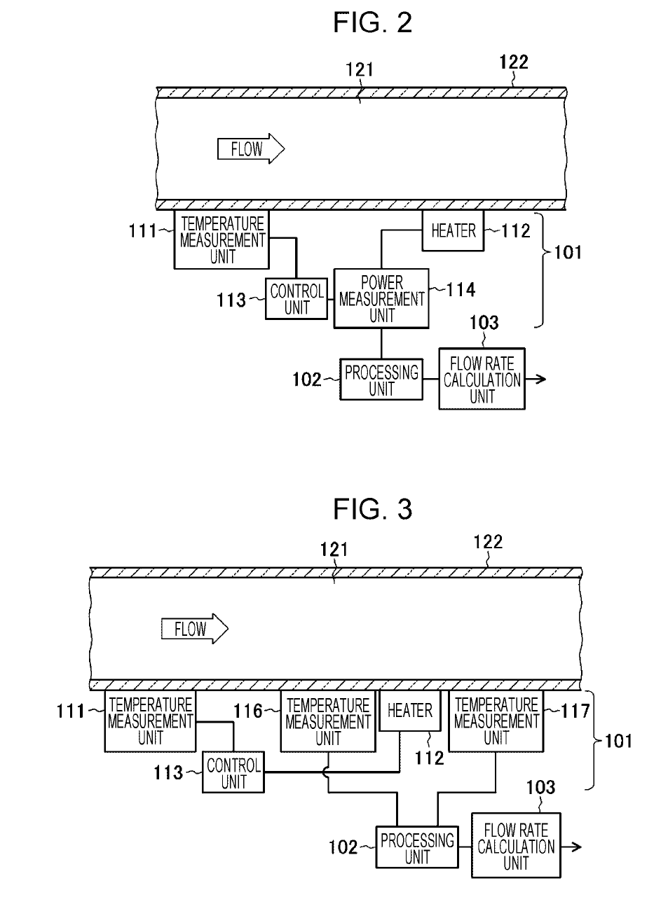

Next, the sensor unit 101 is described in more detail. As illustrated in FIG. 2, the sensor unit 101 includes, for example, a temperature measurement unit 111, a heater 112, a control unit 113, and a power measurement unit 114. The temperature measurement unit 111 is disposed so as to be in contact with the external wall of a pipe 122 used to convey a measurement target fluid 121. The pipe 122 is formed of, for example, glass. The heater 112 is disposed so as to be in contact with the external wall of the pipe 122 downstream relative to the temperature measurement unit 111. The temperature measurement unit 111 measures the temperature of the fluid 121.

The control unit 113 controls and drives the heater 112 so that the difference between the temperature of the heater 112 and the temperature of the fluid 121 measured by the temperature measurement unit 111 at a position where there is no thermal effect of the heater 112, namely, for example, at an upstream position relative to the heater 112, is to be equal to a set temperature difference set in advance. The power measurement unit 114 measures and outputs the power of the heater 112 controlled by the control unit 113. In this example, the power output from the power measurement unit 114 that constitutes the sensor unit 101 is the sensor value. The power of the heater 112 measured and output by the power measurement unit 114, that is, the sensor value, can be used to calculate the flow rate of the fluid 121.

As is well known, when the heater 112 is driven so that the difference between the temperature of the heater 112 and the temperature of the fluid 121 at the position where there is no thermal effect of the heater 112 is to be equal to the set temperature difference, the power consumed by the heater 112 has a correlation with the flow rate of the fluid 121.

This correlation is reproducible for the same fluid, flow rate, and temperature. Therefore, in a state where the heater 112 is controlled by the control unit 113 as described above, the flow rate can be calculated from the power measured by the power measurement unit 114 by using a predetermined correlation coefficient (constant).

Alternatively, the temperature measurement unit the heater 112, the control unit 113, a temperature measurement unit 116, and a temperature measurement unit 117 may constitute the sensor unit 101, as illustrated in FIG. 3.

Here, the temperature measurement unit 111 is disposed so as to be in contact with the external wall of the pipe 122 used to convey the measurement target fluid 121. The heater 112 is disposed so as to be in contact with the external wall of the pipe 122 downstream relative to the temperature measurement unit 111. The temperature measurement unit 111 measures the temperature of the fluid 121.

The control unit 113 controls and drives the heater 112 so that the difference between the temperature of the heater 112 and the temperature of the fluid 121 measured by the temperature measurement unit 111 at a position where there is no thermal effect of the heater 112, namely, for example, at an upstream position relative to the heater 112, is to be equal to a set temperature difference set in advance.

The temperature measurement unit 116 is disposed so as to be in contact with the external wall of the pipe 122 downstream relative to the temperature measurement unit 111 and upstream relative to the heater 112. The temperature measurement unit 117 is disposed so as to be in contact with the external wall of the pipe 122 downstream relative to the heater 112. The temperature measurement unit 116 and the temperature measurement unit 117 each measure the temperature of the fluid 121.

The flow rate of the fluid 121 can be calculated from the temperature difference between the fluid temperature measured by the temperature measurement unit 116 and the fluid temperature measured by the temperature measurement unit 117. In this example, the temperature difference between the fluid temperature measured by the temperature measurement unit 116 and the fluid temperature measured by the temperature measurement unit 117 is the sensor value.

As is well known, when the heater 112 is driven so that the difference between the temperature of the heater 112 and the temperature of the fluid 121 at the position where there is no thermal effect of the heater 112 is to be equal to the set temperature difference set in advance, the temperature difference between the temperature of the fluid 121 at the upstream position relative to the heater 112 and the temperature of the fluid 121 at the downstream position relative to the heater 112 has a correlation with the flow rate of the fluid 121. This correlation is reproducible for the same fluid, flow rate, and temperature. Therefore, in a state where the heater 112 is controlled by the control unit 113 as described above, the flow rate can be calculated from the difference (temperature difference) between the temperature measured by the temperature measurement unit 116 and the temperature measured by the temperature measurement unit 117 by using a predetermined correlation coefficient (constant).

The sensor value P, which is the power or the temperature difference output from the sensor unit 101 configured as described above, is used to obtain an estimated value P′ by using the following equation.

P′=P×(Tup÷ΔT) (1)

Here, ΔT is the difference between the heater temperature and the measured fluid temperature, and Tup is the set temperature difference for the heater by which the heater temperature is higher than the fluid temperature.

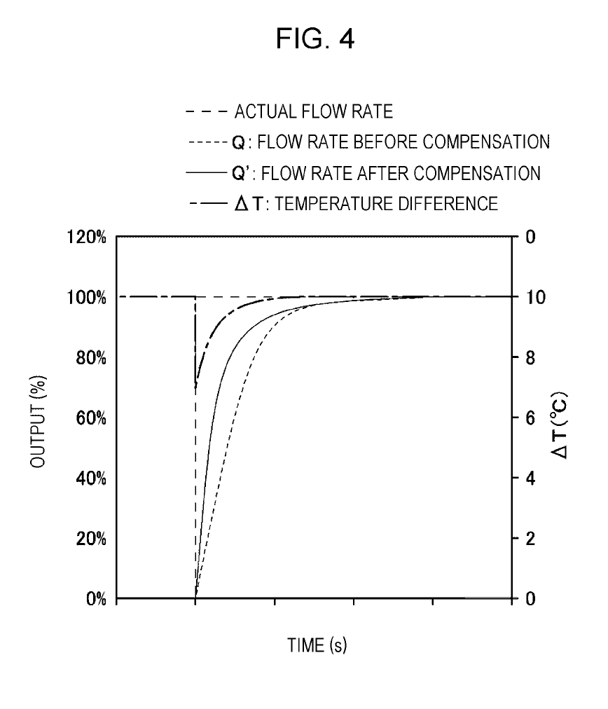

A description of equation (1) is given below. A case is first assumed where the flow rate abruptly changes as indicated by the dashed line in FIG. 4. Even in the case where the flow rate abruptly changes, if the actual flow rate is accurately reflected to the sensor output (first value), the flow rate output by the flow rate calculation unit 103 is to change as indicated by the dashed line in FIG. 4.

However, in the case where the flow rate abruptly changes, a state occurs where the difference ΔT between the heater temperature and the measured fluid temperature temporarily fails to be equal to the set temperature difference Tup (for example, 10° C.), as indicated by the dot-and-dash line in FIG. 4. Specifically, in a case where the measurement target is a liquid, the thermal capacity is large, and therefore, an abrupt change in the flow rate makes the difference between ΔT and Tup larger. After the occurrence of the state where ΔT and Tup are temporarily different from each other, ΔT gradually becomes closer to Tup, and eventually reaches and is kept equal to Tup.

For example, in a case where the flow rate abruptly increases, ΔT temporarily becomes smaller than Tup. In this state, the flow rate calculated from the sensor value P is smaller than the actual flow rate. As described above, when the flow rate abruptly changes, ΔT temporarily changes as indicated by the dot-and-dash line in FIG. 4, and therefore, the flow rate output by the flow rate calculation unit 103 involves a delay in response as indicated by the dotted line.

Here, in a transitional period in which the flow rate abruptly increases, ΔT becomes smaller than Tup, and the flow rate calculated from the sensor value P is smaller than the actual flow rate. In a transitional period in which the flow rate abruptly decreases, ΔT becomes larger than Tup, and the flow rate calculated from the sensor value P is larger than the actual flow rate. In other words, the magnitude relation between ΔT and Tup in a transitional period in which the flow rate abruptly changes is reflected to the sensor value P. Therefore, the estimated value P′ obtained by multiplying the sensor value P by the reciprocal of ΔT/Tup indicating the magnitude relation between ΔT and Tup during a transitional period in which the flow rate abruptly changes is considered to become closer to a value that reflects the actual flow rate.

Accordingly, the estimated value P′ is estimated from the sensor value P by using equation (1) described above, and the estimated value P′ is used to calculate the flow rate. As a result, the flow rate output by the flow rate calculation unit 103 can be made to respond to the actual changing flow rate more closely, as indicated by the solid line.

In the transitional period in which the flow rate abruptly increases, ΔT temporarily becomes smaller than Tup. In this case, the sensor value P is multiplied by Tup/66 T, which is larger than 1, and the estimated value P′, which is a larger value, is used to calculate the flow rate. In the transitional period in which the flow rate abruptly decreases, ΔT temporarily becomes larger than Tup. In this case, the sensor value P is multiplied by Tup/ΔT, which is smaller than 1, and the estimated value P′, which is a smaller value, is used to calculate the flow rate.

In a state where the flow rate gradually changes, a state where ΔT=Tup is satisfied is mostly maintained, which results in Tup÷ΔT≅1 and P≅P′. This state is substantially equivalent to a state where the sensor value P is used in calculation of the flow rate as is.

As described above, according to the first embodiment, the sensor value estimated by using equation (1) is used to calculate the flow rate, and therefore, the thermal flowmeter can determine the flow rate of the measurement target fluid more quickly. Note that a constant k may be used, and the estimated value P′ may be calculated by using the following equation.

P′=P×k×(Tup÷ΔT) (2)

When k=1, equation (2) is equivalent to equation (1). When k is appropriately set from a relation between the actual flow rate and the sensor value P and ΔT obtained from an experiment and P′ is calculated by using equation (2), P′ can be further made closer to the actual flow rate.

### Second Embodiment

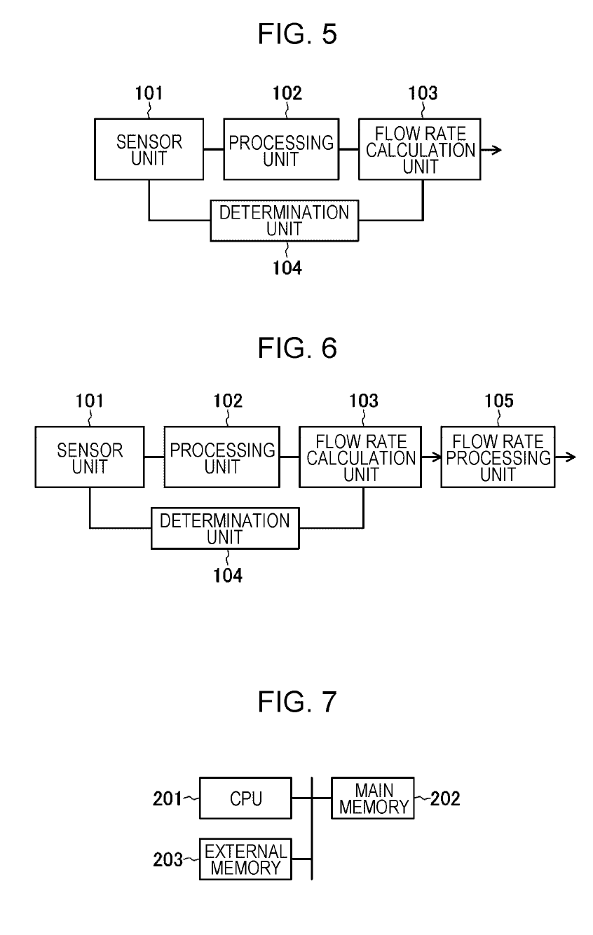

Next, a thermal flowmeter according to a second embodiment of the present disclosure is described with reference to FIG. 5. This thermal flowmeter includes the sensor unit 101, the processing unit 102, and the flow rate calculation unit 103. These are the same as those in the first embodiment described above. In the second embodiment, the thermal flowmeter further includes a determination unit 104 that determines whether the difference between the set temperature difference and the difference between the heater temperature and the measured fluid temperature is smaller than a set value.

In the second embodiment, if the determination unit 104 determines that the difference between the set temperature difference (Tup) and the difference (ΔT) between the heater temperature and the fluid temperature is smaller than a set value, the flow rate calculation unit 103 calculates the flow rate from the sensor value output by the sensor unit 101.

For example, in a case where the flow rate changes to a small degree, if the flow rate calculation unit 103 calculates the flow rate using the sensor value output by the sensor unit 101 as is, a delay in response is not large. This state is a state where the difference between ΔT and Tup is small. In this state, Tup÷ΔT=1 is satisfied but Tup÷ΔT=1 is not satisfied, and therefore, the estimated value P′ changes to a small degree in response to a small change in the flow rate. Accordingly, if the flow rate is calculated by using the second value calculated by the processing unit 102 at all times, in the case where the flow rate changes to a small degree, the flow rate calculated by the flow rate calculation unit 103 fluctuates. In the case where the flow rate changes to a small degree, the difference between ΔT and Tup is small. Therefore, in a case where the difference is smaller than a set value, the flow rate is calculated from the sensor value P output by the sensor unit 101, so that the above-described fluctuation can be suppressed.

### Third Embodiment

Next, a thermal flowmeter according to a third embodiment of the present disclosure is described with reference to FIG. 6. This thermal flowmeter includes the sensor unit 101, the processing unit 102, the flow rate calculation unit 103, and the determination unit 104. These are the same as those in the second embodiment described above.

In the third embodiment, a flow rate processing unit 105 calculates an estimated flow rate Q′ from the flow rate Q calculated by the flow rate calculation unit 103 to make the calculated flow rate respond to the actual changing flow rate more closely. The flow rate processing unit 105 calculates the estimated flow rate Q′ by using the following equation.

Q′=Q+A×Q×dQ/dt (3)

Here, A is a compensating rate and is determined in advance. The difference between the estimated flow rate Q′ and the actual changing flow rate changes in accordance with the value of the compensating rate A.

As the compensating rate A increases, the estimated flow rate Q′ may fluctuate. Therefore, the compensating rate A is set in accordance with a desired degree of the difference between the estimated flow rate Q′ and the actual changing flow rate. In a case where the time derivative value of the flow rate dQ/dt is equal to or smaller than a predetermined value, the flow rate processing unit 105 does not estimate the flow rate, and the flow rate Q calculated by the flow rate calculation unit 103 is output as is to thereby attain stability in a case where the flow rate is steady.

The processing unit 102, the flow rate calculation unit 103, the determination unit 104, and the flow rate processing unit 105 are implemented as a computer that includes, for example, a central processing unit (CPU) 201, a main memory 202, and an external memory 203, as illustrated in FIG. 7. When the CPU operates in accordance with a program loaded to the main memory, the above-described functions are implemented.

As described above, according to the present disclosure, the set temperature difference by which the heater temperature is higher than the fluid temperature is divided by the difference between the heater temperature and the measured fluid temperature, and the sensor value is multiplied by the value obtained as a result of the division to estimate the flow rate. Therefore, the thermal flowmeter can determine the flow rate of the measurement target fluid more quickly.

Note that the present disclosure is not limited to the embodiments described above, and it is obvious that various modifications and combinations may be made by a person having ordinary skill in the art without departing from the technical spirit of the present disclosure.

What is claimed is:

1. A thermal flowmeter comprising:
a sensor unit including a heater that heats a measurement target fluid, and configured to output a first value that corresponds to a thermal diffusion state of the fluid heated by the heater when the heater is driven so that a difference between a temperature of the heater and a temperature of the fluid at a position where there is no thermal effect of the heater is to be equal to a set temperature difference;
a processing unit configured to calculate a second value obtained by multiplying the first value by a value obtained by dividing the set temperature difference by a difference between the temperature of the heater and a measured temperature of the fluid; and
a flow rate calculation unit configured to calculate a flow rate of the fluid from the second value calculated by the processing unit.

2. The thermal flowmeter according to claim 1, wherein
the processing unit calculates the second value by multiplying the first value by the value obtained by dividing the set temperature difference by the difference between the temperature of the heater and the measured temperature of the fluid and by a preset constant.

3. The thermal flowmeter according to claim 1, further comprising
a determination unit configured to determine whether a difference between the set temperature difference and the difference between the temperature of the heater and the measured temperature of the fluid is smaller than a set value, wherein
if the determination unit determines that the difference between the set temperature difference and the difference between the temperature of the heater and the measured temperature of the fluid is smaller than the set value, the flow rate calculation unit calculates the flow rate from the first value.

4. The thermal flowmeter according to claim 1, further comprising
a flow rate processing unit configured to add the flow rate calculated by the flow rate calculation unit to a value obtained by multiplying the flow rate by a time derivative value of the flow rate and by a set compensating rate to calculate a third value.

5. The thermal flowmeter according to claim 1, wherein
the sensor unit outputs, as the first value, a power of the heater when the heater is driven so that the difference between the temperature of the heater and the temperature of the fluid at the position where there is no thermal effect of the heater is to be equal to the set temperature difference.

6. The thermal flowmeter according to claim 1, wherein
the sensor unit outputs, as the first value, a temperature difference between a temperature of the fluid at an upstream position relative to the heater and a temperature of the fluid at a downstream position relative to the heater when the heater is driven so that the difference between the temperature of the heater and the temperature of the fluid at the position where there is no thermal effect of the heater is to be equal to the set temperature difference.

7. The thermal flowmeter according to claim 1, wherein
the sensor unit further includes a temperature measurement unit disposed so as to be in contact with an external wall of a pipe used to convey the fluid, and configured to measure the temperature of the fluid, and
the heater is disposed so as to be in contact with the external wall of the pipe.
